(19) United States
(12) Patent Application Publication
(10) Pub. No.: US 2003/0200528 A1
(43) Pub. Date: Oct. 23, 2003

(54) Support for wild card characters in code assistance

(75) Inventor: Jin Li, Toronto (CA)

Correspondence Address: Jeffrey S. Labaw, International Business Machines, Intellectual Property Law, 11400 Burnet Rd., Austin, TX, 78758, US

(73) Assignee: International Business Machines Corporation, Armonk, NY

(21) Appl. No.: 10/405,414

(22) Filed: Apr. 1, 2003

(30) Foreign Application Priority Data
Apr. 17, 2002 (CA) 2,382,195

(51) Int. Cl. G06F 9/44

(52) U.S. Cl. 717/110

(57) ABSTRACT

A code assistance feature of a code editor in a software development tool provides support for wild card characters. That is, wild card characters may be included in a search term before triggering the code assistance feature. Rather than the prior approach of appending the search term with a suffix based on a selected search result, the search term is replaced by the selected search result.

### FIELD OF THE INVENTION

The present invention relates to software development tools and, more particularly, to support for wild card characters in a code assistance feature of such tools.

### BACKGROUND OF THE INVENTION

The task of writing an application program is often simplified, for a programmer, by the use of software development tools. Such software development tools typically have several components that may work together or separately to allow the editing, execution and debugging of software code. In particular, the editor component may have built-in features that may anticipate the needs of the programmer. This anticipation is possible because so much of programming can be predictable and may require use of “parts” from predetermined sets of such parts. An example of such a “part” is an application programming interface (API). An API is a specific method prescribed by a computer operating system or by an application program by which a programmer can make requests of the operating system or another application.

While editing the code of an application program, the programmer may, for example, need to insert the name of an API. A standard code editing component (editor) may include a code assistance feature. To use a standard code assistance feature, the programmer may, in the editor, type the initial string of characters in the name of the API of interest and then trigger code assistance. The code assistance feature is typically triggered by users typing “Ctrl+Space” or “.”. Responsive to this trigger, the code assistance feature performs a table lookup with the initial string of characters as a search term. For example, if the programmer was to type “Default” and hit “Ctrl+Space”, all the APIs, for the operating system or application program of interest, that start with the term “Default” will be found as matches in the table lookup, and the search results will be shown in a code assistance listbox. The listbox may be, for instance, a small window listing all APIs found by the table lookup. The programmer may then select, say with a pointing device such as a mouse, the API that is intended for the application program.

Unfortunately, as operating systems and application programs grow in complexity, the number of APIs is ever increasing. As a consequence of the increasing complexity, the number of APIs that have the same initial string is also increasing. The result of a simple table lookup may be hundreds of APIs. As such, it may be easier to type the full name of the API rather than visually search the entire list of APIs that match the initial string of characters typed by the programmer. In this case, the code assistance feature has not simplified the task of writing the application.

### SUMMARY OF THE INVENTION

A code assistance feature of a code editor in a software development tool provides support for wild card characters. That is, wild card characters may be included in a search term before triggering the code assistance feature. In a preferred embodiment, rather than the prior approach of appending the search term with a suffix based on a selected search result, the search term is replaced by the selected search result.

In accordance with an aspect of the present invention there is provided a method of providing a code assistance feature for a code editor, where the code assistance feature supports use of wild card characters. The method includes retrieving a search term from the code editor, where the search term includes at least one wild card character and replacing the search term in the code editor with a search result, where the search result is received from a table lookup algorithm and selected by a user of the code editor. According to other aspects of the present invention, a software development tool comprising an editor with a code assistance feature capable of performing this method is provided, along with a system for software development for carrying out the method. Additionally, there is provided a computer readable medium for allowing a general purpose computer to perform this method.

In accordance with another aspect of the present invention there is provided a method of providing a code assistance feature for a code editor, where said code assistance feature supports use of wild card characters. The method includes receiving a trigger, the trigger indicating a desire for code assistance and, responsive to the receiving the trigger, retrieving a search term from the editor, the search term including at least one wild card character. The method further includes passing the search term to a table lookup algorithm capable of handling wild card characters. According to another aspect of the present invention, there is provided a computer readable medium for allowing a general purpose computer to perform this method.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate example embodiments of this invention:

FIG. 1 illustrates steps in a code assistance method according to an embodiment of the present invention; and

FIG. 2 illustrates a software development system.

### DETAILED DESCRIPTION

Wild card characters are generally very familiar to computer users. By convention, the “*” character may be used as a wild card character in a search. The “*” character acts as a place holder for any number of characters (or no characters at all). Thus, a search of a dictionary with “dog*” as the search term would yield (among others): dog; dogfight; doggerel; doghouse; dogma. Similarly, by convention, the “?” character may be used as a wild card character in a search. The “?” character acts as a place holder for a single character. Thus, a search of a dictionary with “c?t” as the search term would yield (among others): cat; cot; cut.

In overview, the present invention provides support for wild card characters in a code assistance feature of a code editor. To provide this support, two aspects of the typical operation of a code assistance feature are altered. In the first of these aspects, the table lookup algorithm, which is typically part of a code assistance feature, is altered to perform a search of a table look up reflecting a pattern match for a search term rather than an exact match. In the second of these aspects, the search term is replaced by a selected term rather than appending characters to the search term.

The conventional table lookup algorithm of a typical code assistance feature, for example, from a table of names of APIs, in response to a trigger, receives the character string preceding the cursor as a search term at the time of the trigger receipt or the time the development tool receives the user initiated trigger. The table lookup algorithm then attempts to find those APIs whose initial characters match the search term exactly.

The table lookup algorithm of a code assistance feature using methods exemplary of the present invention receives the character string preceding the cursor as a search term at the time of the trigger receipt, in common with that which is typical. In contrast to the conventional table lookup algorithm, the table lookup algorithm of the inventive code assistance feature employs pattern matching to find APIs that satisfy the search term. Thus, the search term may include wild card characters, such as the “?” and “*” characters discussed hereinbefore. Notably, where the search term does not include any wild card characters, the table lookup algorithm may return APIs whose name includes the search term elsewhere than the initial string.

The typical code assistance feature, once the table lookup algorithm has returned search results, displays the search results in a code assistance listbox. Responsive to the programmer selecting an API from the search results, the search term is cropped from the name of the selected API and the remaining string is appended to the search term in the editor. For example, if the search term is “Default” and the API named “DefaultMutableTreeNode” is selected from the search results presented in the listbox, the cropped text (i.e., “MutableTreeNode”) may be appended to the search term (i.e., “Default”) that is pre-existing in the editor.

The code assistance feature using methods exemplary of the present invention, once the table lookup algorithm has returned search results, displays the search results in a code assistance listbox, as is typical. Responsive to the programmer selecting an API from the search results, the search term is replaced in the editor with the name of the selected API. For example, if the search term is “Default*u” and the API named “DefaultMutableTreeNode” is selected from the search results presented in the listbox, the entire text of the API name (i.e., “DefaultMutableTreeNode”) may be used to replace the entire text of the search term (i.e., “Default*u”).

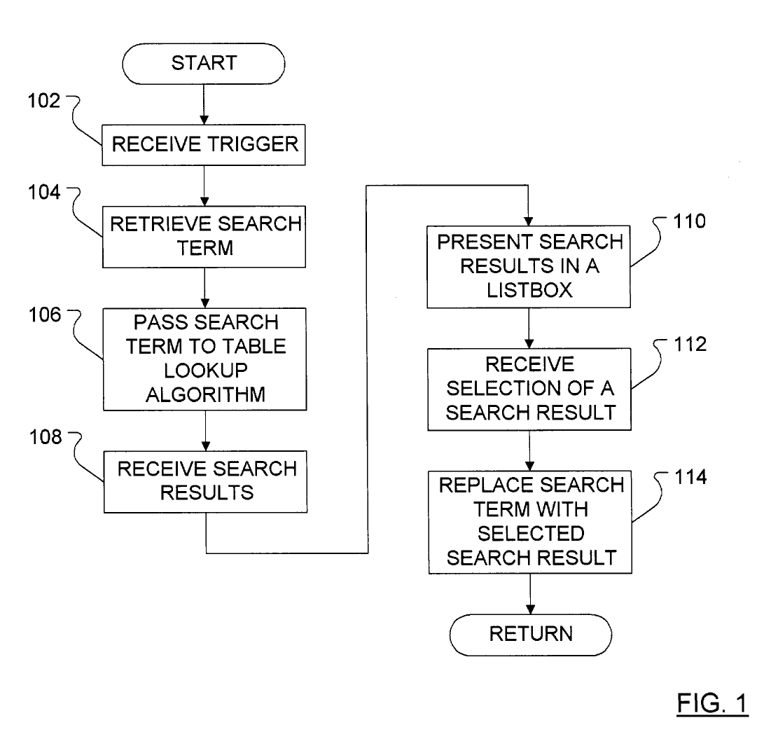

FIG. 1 illustrates steps in an inventive code assistance method. Upon receiving a trigger (step 102), the search term is retrieved (step 104) from the editor. The search term is then passed to a table lookup algorithm (step 106). As described hereinbefore, the table lookup algorithm supports the inclusion of wild card characters in the search term. The table lookup algorithm returns search results that are received (step 108). These search results are then presented in a listbox (step 110). Advantageously, where a wild card has been used in the search term, it is anticipated that the number of search results presented in the listbox will be significantly fewer than the number of search results that would have been presented in the listbox had a wild card not been used. The selection of one of the search results, say, a particular API, is then received (step 112). Responsive to the receipt of this selection, the search term in the editor is replaced with the selected search result (step 114).

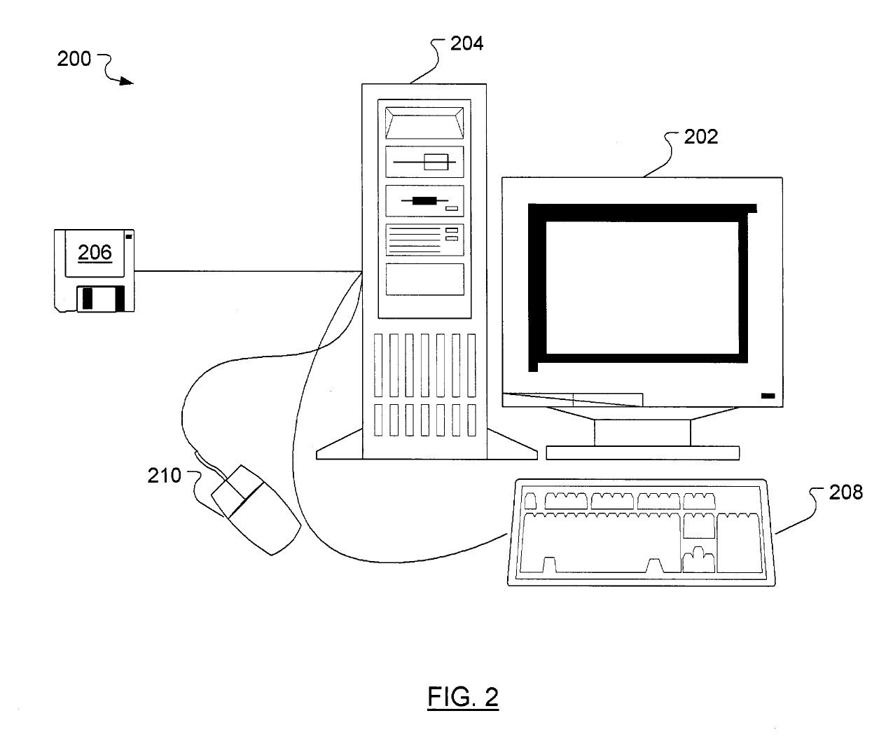

A software development system 200, capable of code assistance, is illustrated in FIG. 2. The software development system 200 includes a display monitor 202 and a central processing unit 204. The central processing unit 204 may include hardware to network with other computers, long term and short term memory and a processor. As is typical, connected to the central processing unit 204 may be multiple input peripherals such as a keyboard 208 and a mouse 210. The software development system 200 may be loaded with a software development tool for executing methods exemplary of this invention from a software medium 206 which could be a disk, a tape, a chip or a random access memory containing a file downloaded from a remote source.

As will be apparent to a person skilled in the art, table lookup algorithms capable of handling wild card characters include the Knuth-Morris-Pratt string matching algorithm described in Knuth, D. E., Morris (Jr.) J. H., Pratt, V. R., 1977, Fast pattern matching in strings, SIAM (Society for Industrial and Applied Mathematics) Journal on Computing 6(1):323-350 and the Boyer-Moore algorithm described in Boyer R. S., Moore J. S., 1977, A fast string searching algorithm, Communications of the ACM (Association for Computing Machinery) 20:762-772. Both of these publications are hereby incorporated herein by reference.

Advantageously, the search results are not limited to those having an initial string of characters that is the same as the search term, as is the case in traditional code assistance. As such, if the programmer knows that the final string of the API of interest is more unique than the initial string, the search term may be entered as “*Node”, for instance, to keep the number of search results low.

Other modifications will be apparent to those skilled in the art and, therefore, the invention is defined in the claims.

The embodiments of the invention in which an exclusive property or privileged is claimed are defined as follows:

1. A method of providing a code assistance feature for a code editor, where said code assistance feature supports use of wild card characters, said method comprising:
retrieving a search term from said code editor, where said search term includes at least one wild card character; and
replacing said search term in said code editor with a search result, where said search result is received from a table lookup algorithm and selected by a user of said code editor.

2. A software development tool comprising an editor with a code assistance feature operable to:
retrieve a search term from said editor, where said search term includes at least one wild card character; and
replace said search term in said editor with a search result, where said search result is received from a table lookup algorithm and selected by a user of said software development tool.

3. A system for software development comprising a processor adapted to:
present a code editor having a code assistance feature operable to:
retrieve a search term from said editor, where said search term includes at least one wild card character; and
replace said search term in said editor with a search result, where said search result is received from a table lookup algorithm and selected by a user of said software development tool.

4. A computer readable medium containing computer-executable instructions which, when performed by a processor in a computer system for software development, cause the computer system to:
present a code editor having a code assistance feature operable to:
retrieve a search term from said editor, where said search term includes at least one wild card character; and
replace said search term in said editor with a search result, where said search result is received from a table lookup algorithm and selected by a user of said software development tool.

5. A method providing a code assistance feature for a code editor, where said code assistance feature supports use of wild card characters, said method comprising:
receiving a trigger, said trigger indicating a desire for code assistance;
responsive to said receiving said trigger, retrieving a search term from said editor, said search term including at least one wild card character; and
passing said search term to a table lookup algorithm capable of handling wild card characters.

6. The method of claim 5 further comprising:
receiving a plurality of search results from said table lookup algorithm;
presenting said plurality of search results in a listbox;
receiving an indication of a selected one of said plurality of search results; and
responsive to said receiving said indication, replacing said search term in said editor with said selected one of said plurality of search results.

7. The method of claim 5 wherein said at least one wild card character is a character.

8. The method of claim 7 wherein said “*” character is representative of zero or more characters.

9. The method of claim 5 wherein said at least one wild card character is a “?” character.

10. The method of claim 9 wherein said “?” character is representative of one character.

11. The method of claim 6 wherein said plurality of search results are names of application programming interfaces.

12. A computer readable medium containing computer-executable instructions which, when performed by a processor in a computer system for software development, cause the computer system to:
receive a trigger, said trigger indicating a desire for code assistance;
responsive to said receiving said trigger, retrieve a search term from a code editor, said search term including at least one wild card character; and
pass said search term to a table lookup algorithm capable of handling wild card characters.
